(19) United States
(12) Patent Application Publication
(10) Pub. No.: US 2005/0188853 A1
(43) Pub. Date: Sep. 1, 2005

(54) Multifunction-capable health related devices

(76) Inventor: Robert F. Scannell JR., Lebanon, NJ (US)

Correspondence Address: Kenneth P. Glynn, 24 Mine Street, Flemington, NJ, 08822, US

(21) Appl. No.: 11/101,066

(22) Filed: Apr. 7, 2005

Related U.S. Application Data
(63) Continuation-in-part of application No. 11/062,039, filed on Feb. 18, 2005.
(60) Provisional application No. 60/545,939, filed on Feb. 20, 2004.
(60) Provisional application No. 60/560,908, filed on Apr. 10, 2004.
(60) Provisional application No. 60/607,961, filed on Sep. 8, 2004.

(51) Int. Cl. B01D 46/00

(52) U.S. Cl. 96/417

(57) ABSTRACT

Health and environmental devices such as air purifiers are adapted with components for multifunctional capabilities that involve electronic devices and associated housings containing at least one processor adapted to operate at least one component selected from the group consisting of air purifiers, sensors, local area and wide area networked components, and entertainment and electronic components. Health and safety related containers, covers and information input, processing, and output devices include one or more coded data readers for use with bar code, radio frequency identification (RFID) and other coded data technologies and comprise components to support at least one of the following: communications; networked sensors; and monitoring applications. Increased efficiencies in the use of coded data reader systems that include such coded readers and the associated items being read are supported by alignment indicia adapted for being on said items being read and on said reading devices.

### REFERENCES TO RELATED APPLICATIONS

This application is based on and claims priority on U.S. Provisional Patent Application No. 60/545,939, entitled, “Lighting fixture, switch assembly & enclosure with interconnecting, interchangeable and modular components” and filed on Feb. 20, 2004, on U.S. Provisional Patent Application No. 60/560,908, entitled, “Multi-utility fixtures, enclosures, pedestals, and bases with interchangeable, modular, integrated and/or networked components” and filed on Apr. 10, 2004, and on U.S. Provisional Patent Application No. 60/607,961, entitled, “Medication & health, environmental, and security monitoring, alert, intervention, information, network system” and filed on Sep. 8, 2004. This application is a continuation-in-part of copending United States utility patent application by the same inventor herein on Feb. 18, 2005, entitled MULTIFUNCTION-ADAPTABLE, MULTICOMPONENT DEVICES, having an Attorney Docket No. RFS-105A and a Ser. No. of 11/062,039.

### BACKGROUND OF THE INVENTION

1. Field of the Invention

The present invention relates to health and dwelling environmental devices such as air purifiers that are adapted with housings and other components for modular expansion, optimal purifier and filter configurations, and multifunctional capabilities, including additional air purifier components and functions and non-air purifier components and functions that involve electrical and/or electronic devices where any one of the preceding may be or be associated with, but not limited to, the use of modules containing at least one processor adapted to operate at least one power consuming component selected from the group consisting of air purifiers, sensor components, local area networked components, wide area networked components, communications components, entertainment components and electronic components. The present invention also relates to health, safety, and/or security related containers, covers, information perceiving and receiving components and/or devices, information processing and output components and/or devices, and combinations thereof that are associated with or include one or more information recognition means, specifically, coded data readers such as bar code readers (such as linear bar codes and two-dimensional bar codes), radio frequency identification (RFID) technology readers, printed data encoding technology readers, magnetic stripe, tape or storage readers, optical hologram readers, Optical Character Recognition (OCR) readers, and DNA-mark readers and may comprise components to support one or more of, but not limited to, the following functions: medical/health; wireless and wire-based communications applications; networked (wireless and/or wired) sensor applications; security and/or authenticity applications; and monitoring applications (motion detection, surveillance, environmental or health/safety). One of the primary utilities of the invention is to provide greater function, economic and environmental utility, safety, and variety for the end user or consumer (residential, commercial, hospital, institutional or governmental) with respect to utilizing many of the applications stated in the preceding sentences in an incremental manner, and also provide greater function and utility for a variety of constituents associated with the industries represented in the preceding sentence. Another aspect of the present invention relates to increased efficiencies in the use of information perceiving, receiving and output devices and the associated items or materials being read that utilize one or more of the following coded information or mark means: bar code (such as linear bar codes and two-dimensional bar codes); radio frequency identification (RFID) technology; printed data encoding technology; magnetic stripe, tape or storage; optical holograms; Optical Character Recognition (OCR) technology; and DNA-mark technology and may comprise components to provide enhancing alignment indicia, both on the reading and/or scanning devices and on the items or materials being read.

2. Information Disclosure Statement

The following prior art references relate to the present invention fields of endeavor, and are of interest as prior art:

U.S. Pat. No. 5,353,546 to Ronald F. Bock describes a combination vase and air fragrance dispenser comprised of two interconnecting vessels, one to hold natural or artificial flowers, the other to hold air treatment material and dissipate fragrance to the atmosphere. Its two-vessel construction makes it possible to completely separate flowers and air treatment material, preventing contamination of the flowers.

U.S. Pat. No. 5,477,620 to Reinhold Holtkamp, Jr. describes a fragrance emitting plant watering system having a bottom vase providing a reservoir for water supply for a potted plant, an air freshener cartridge supported on the vase, a cap adapted to overtie the cartridge and having a central section for supporting a plant, and wherein the cap is adjustable relative to the vase for movement between a first position in which the cap is raised to variably expose the cartridge to emit fragrance, and a second position in which the cap substantially covers the cartridge to seal said cartridge and inhibit fragrance emission.

U.S. Pat. No. 6,478,440 B1 to Thomas Jaworski et al. describes an air freshener dispenser that is taught having plug-through capability as well as a night light. The dispenser is a plug-in diffuser for such active materials as fragrances and air fresheners, and eliminates the consumer problem of loss of an electrical outlet, by providing a receptacle into which another plug may be inserted. The dispenser uses replaceable cartridges of material to be dispensed, and provides a night light for those who desire such.

U.S. Pat. No. 6,548,967 B1 to Kevin J. Dowling et al. describes smart lighting devices bearing processors, and networks comprising smart lighting devices, capable of providing illumination, and detecting stimuli with sensors and/or sending signals. Sensors and emitters can, in some embodiments, be removed and added in a modular fashion. Smart lighting devices and smart lighting networks can be used for communication purposes, building automation, systems monitoring, and a variety of other functions.

Unites States Patent Application Publication No. US 2001/0053283 A1 describes the invention that provides a method and apparatus for controlling the temperature of a liquid vaporizer heating element, and thereby the rate of evaporation and level of fragrance deliver for the same. In accordance with one exemplary embodiment of the present invention, the device may include a switch that suitably allows the temperature of various types of heating elements to be controlled for different levels of fragrance output. For example, an exemplary embodiment may include a two-pronged plug adaptable to typical outlets that might be found in residential homes or businesses. In accordance with another exemplary embodiment of the present invention, the electrical switch generally provides varying resistance values to the electric circuitry of the vaporizer such that, by changing the switch setting, the operating temperature of the wick is controlled and thus the rate of fragrance evaporation from the vaporizer.

The following pending United States Pending Patent Applications are also of interest to the fields of the technology of the present invention:

United States Patent Application Publication No. US 2001/0049608 A1 to Mark N. Hochman describes an automated drug administering system such as an injection device or infusion pump that is provided with means for reading information from a container holding the drug. The information is then checked for accuracy before the administration of the drug. Optionally, an ID tag on the patient and/or the health care professional providing the drug may also be scanned and checked. The information thus gathered is sent to another station where it is logged for future use and analyzed.

United States Patent Application Publication No. 2002/0022973 A1 to Jianguo Sun et al. describes a medical information management system and method that stores and manages patient information and that enables a patient an authorized party, such as a friend or family member, to access the patient's medical information. The presentation format, substance of the patient's medical information or both are customized depending on whether the patient, a healthcare professional or the third party is accessing the patient's medical information. The system also pertains to a method of subsidizing such a medical information system by selling advertising space in the presentation shown to the third party, patient, or the healthcare professional. The system further pertains to a patient interface appliance that includes a display containing multiple viewing fields, one of which is a general information field and one of which is an advertising field, to present information and advertisements to a user during a patient interface session. Patient participation to conducting the survey is fostered by offering a survey completion reward to the patient upon completing the survey.

United States Patent Application Publication No. US 2002/0026330 A1 to Edward E. Klein describes an invention that relates to a system and a method to manage athe administration of medication to a patient. In particular, the system and method of the invention maintains a database of medications to be taken by a patient. The database includes at least the medication name, dosage, and administration time or frequency of administration. In addition, the database may contain specific cautionary warnings and notices regarding the administration of the medication. The system and method monitors the medication schedule to determine the time that a particular medication should be administered. Once an administration time has been determined, a notification is provided to a patient or caregivers at the appropriate time indicating the particular medication to administer. The system and method then determines the identity of a medication chosen by the patient or caregiver to be administered and compares the medication to the medication identified in the medication schedule. The system and method then determines whether the correct medication has been chosen by the patient or caregiver for administration, and reports the results.

United States Patent Application Publication No. US 2003/0086338 A1 to Srikonda V. Sastry et al. describes a wireless, web based system for monitoring patient drug compliance that includes a plastic container that holds a wireless device, the patient's drugs and a cpu programmable remotely and automatically from normal computer input by health care providers and pharmacists to control the functioning of the wireless transceiver and a variety of sound, vibration, light, and readable screen for reminders and to provide drug related information. A sensor detects and wirelessly reports the opening of the medicine container in real time to remind the patient, when noncompliance occurs, on the patient's portable device and also telephones or pages the patient as additional reminders. The web site program analyzes models and interprets the data to provide important drug noncompliance information to healthcare professionals. The container may further comprise a sensor means for temperature, blood pressure, and blood chemistry data including blood glucose, creatinine and others which may all be transmitted wirelessly.

United States Patent Application Publication No. US 2003/0099158 A1 to Carlos D. la Huerga describes an invention that relates to an interactive medication container or console that hold or otherwise organizes one or more medication vials or containers. Each vial has a memory strip containing medication and prescription information. Each vial can also include a reminder unit that is attached to and portable with the individual vials. The console or reminder unit reads the information strip of the vial and communicates this information to or interacts with a patient to remind them to take the medication. The medication container or reminder unit also gathers or tracks information such as consumption time, quantity remaining, patient feedback, and contraindication information. The medication container or reminder unit interacts with the patient by displaying questions or receiving and recording input from the patient before, during or after a dose of medication is taken. The patient input can be used to modify dosage regimen for future doses of medication. The medication container reorders medication when the quantity remaining reaches a threshold level. Contraindication information in the memory strip is downloaded to a personal home computer or a hospital or nursing home computer.

United States Patent Application Publication No. US 2003/0189089 A1 to David Raistrick describes an apparatus and method permitting an information challenged person to determine the content of pharmaceutical information contained in a label placed on a medicine container. The apparatus comprises, in one embodiment, a two-dimensional bar code label and in a second embodiment, a radio frequency identification label, a reader and processing unit. The reader scans the label located on the medicine container, the label information is then decoded by a processing unit and text information for audio and/or video dissemination to the information challenged person.

Notwithstanding the prior art, the present invention is neither taught nor rendered obvious thereby.

### SUMMARY OF THE INVENTION

The present invention provides for the means to have air purifiers that are adapted with housings and other modular components for modular expansion, optimal purifier and filter configurations and multifunctional capabilities, including additional air purifier components and functions and non-air purifier components and functions that involve electrical and/or electronic devices where any one of the preceding may be or be associated with, but not limited to, the use of modules containing at least one processor adapted to operate at least one power consuming component selected from the group consisting of air purifiers, sensor components, local are networked components, wide area networked components, communications components, entertainment components and electronic components to enhance the end users' use, safety, convenience and pleasure of a living or work space. Such invention products and/or systems may have one or more components or interconnected components that may be modified, replaced, upgraded or added to such product or system by, but not limited to, the end user or consumer as the user desires.

One of the major advantages of the present invention is to provide for, at minimum, optimal air purifier and filter technology means to the end user, as well as, utilizing the numerous functions (air purifier and non-air purifier) that are available from a variety of electronics (including, but not limited to switches, processor-based and/or electrically powered) and communications products in a more adaptable, integrated and enhanced means with new utilities without the need for purchasing such products in an integrated system all at once or cluttering the living and work space with such items when purchased incrementally in standalone form. Optimal air purifier technology applications may differ amongst users as users needs differ. Air ionizers effectively remove many particulates such as bacteria, mold, dust, other allergens from the air, as well as ultra-fine particles of smoke, viruses and chemical fumes. High Efficiency Particulate Air Filters (HEPA) or filters capable of capturing 99.97% of particles as small as 0.3 microns are largely considered as being most effective for removing solid particles such as allergens. Filtering systems utilizing germicidal ultra-violet (UV) light are effective for destroying a large variety of microbial contaminates, such as viruses, germs, bacteria and fungi. Activated carbon air filters are highly effective for capturing and neutralizing chemicals, gases, odors and cigarette smoke. Ozone generators, though potentially harmful, when used prudently (especially when integrated with a present invention timer component), may serve as odor eliminators when other means are not effective, as well as a close range powerful disenfectant. The means for providing a user or users with the preceding purifying capabilities, as well as a variety of other components (such as, but not limited to, from pre-filters for prolonging system filter to ionized oxygen generators), and future filtering, purifying and generator improvements and technologies, in an integrated and/or modular system in an incremental and economical manner supports a greater likelihood of use for the air purifier technology(ies) that is most appropriate for the respective user or users. One of the means for providing such utilities is to incorporate such numerous functions in systems comprising at least one or more components adapted for being comprised, integrated, networked or connected of, in or with at least one air purifier, and in some preferred cases, an integration of or network of such air purifier technologies and/or devices. These may further be integrated or networked with other such systems with the parts, materials and characteristics described herein.

Advantageously, the invention embodiments may be adapted with one or more interconnecting, integrated, networked, interlocking or inter-fastening component(s) with associated electrical, communications (such as, but not limited to, ZigBee) data interface and/or circuitry connections (such as, but not limited to, USB for certain data and networked connections), as appropriate, to support interaction (in a variety of forms), modification, upgrade or sub-component (including filter) replacement.

The present invention is also a system that consists of devices, sensors (including medical, environmental, and security), networked products, communications processors and components, a variety of alert and information components, processors, and software to support at least one or more of the following: 1) facilitating a variety of processes and process compliance, from material handling, tracking, and handling compliance to identity authentication; 2) facilitating medication regimen and patient/user health administration, dosage control, tracking, compliance, information inquiry and presentation, reminder and notification; 3) providing monitoring, information, ordering, and intervention means in conjunction with such devices and software through components and systems that may be available in standalone or integrated forms; 4) presenting the option of leveraging preventative means, alert and notification components with other present invention components to facilitate user, occupant and/or worker well being, along with living, work area, dwelling, and/or facility environmental and/or security safety; and 5) enhancing such dwelling, living or work area with products (including the present invention air purifier products) that may be networked to support the widespread acceptance of all present invention innovations described herein and their associated embodiments. The integration and networked means associated with the preceding may support the following: a) processing, centralizing and communicating device commands and/or programs; b) device administration; c) patient/worker/user information; d) dwelling environmental safety; e) security breach information; and/or f) centralized and remote apparatus and system activations through at least one primary component and/or at least one backup embodiment. The intent for such embodiments is to provide the following: 1) economical and efficient care and/or safety; 2) information dissemination; and 3) response.

One of the primary utilities of the present invention system is to provide an economical and highly reliable means for and/or through third parties and/or remote components regarding the following: 1) medication administration, compliance, ordering, patient health monitoring, patient medical and vital information inquiry and presentation (different criteria and content used pending on inquiry source—family, case worker, nurse, doctor, etc.); 2) medical device metrics, device operations and programming; and 3) exception reporting, notification and intervention. Another characteristic of the present invention system is the broad applications of some of the invention components with respect to medical, industrial and commercial processes requiring high levels of compliance and safety.

Another primary utility of the present invention system is to provide unique products with networking means to enhance a work, living, and/or dwelling area to contribute optimal utilities when networked and interacting with other present invention components to support widespread system acceptance. One of the keys to achieving such widespread acceptance of such present invention embodiments, especially in a networked means, is offering such embodiments in conjunction with at least one associated apparatus that provides a compelling framework and value that utilizes existing infrastructure whereby such present invention embodiment, when coupled with such associated apparatus at a relatively low incremental cost, offers a new utility and a bridge for more utilities, applications, and a means for such widespread acceptance of the present invention system described herein and its associated embodiments.

For example, one of the present invention embodiments of the medical and health innovations described herein is a dispenser material tracking and medication aid system where such system may be a standalone system or comprise Local Area Network and/or Wide Area Network communications capabilities. As a standalone system, it facilitates medication regimen compliance. As a networked system, it provides a compelling framework for the user and interested third parties in enhancing the facilitation of medication regimen compliance. Such system may be in a framework that includes other present invention medication aid and intervention devices such as a stationary or docked main device and/or a portable main device, where such devices may enhance the user's use of such present invention medical and health devices and system.

Another component of the present invention is to support third party engagement through (a) server(s) and/or associated server-based services (which may include, but are not limited to, intra, inter, and/or extranet, as well as hosting and/or messaging capabilities).

### BRIEF DESCRIPTION OF THE DRAWINGS

The present invention should be more fully understood when the specification herein is taken in conjunction with the drawings appended hereto wherein:

FIGS. 1 through 15 show various stages, components and combinations of elements for a preferred embodiment of a present invention singular air purifier unit device;

FIGS. 16 through 23 illustrate a present invention main device for facilitating medicine and other health related product administration and tracking. The term “medicine” is used herein broadly to include prescription medications, OTC medications, vitamins, supplements, nutritional products and other health care products. These Figures show table and portable modules and various components and features of each;

FIGS. 24 through 27 show present invention embodiments of medication aid devices and associated components with alignment features to increase the efficiency of the uses thereof.

### DETAILED DESCRIPTION OF THE PRESENT INVENTION

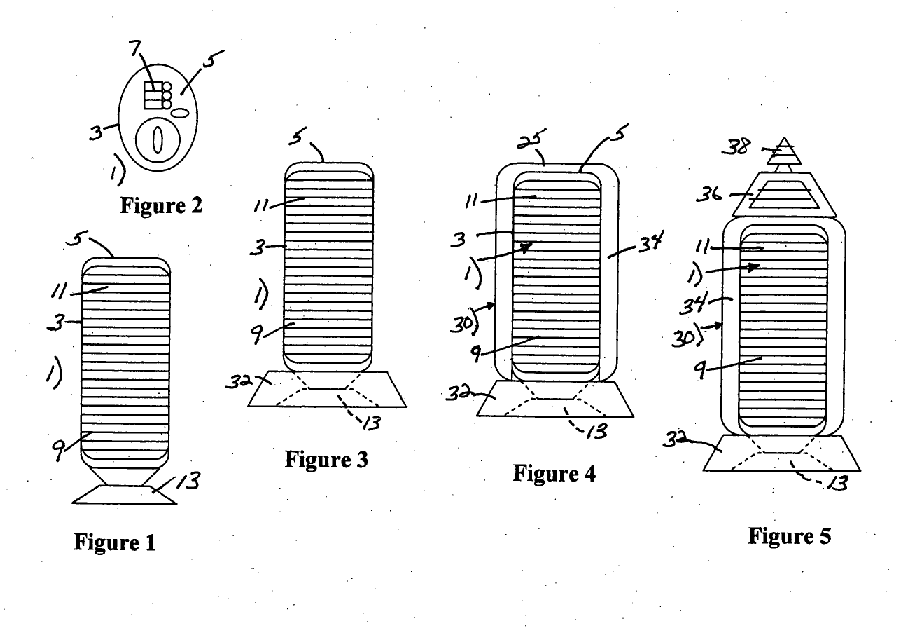

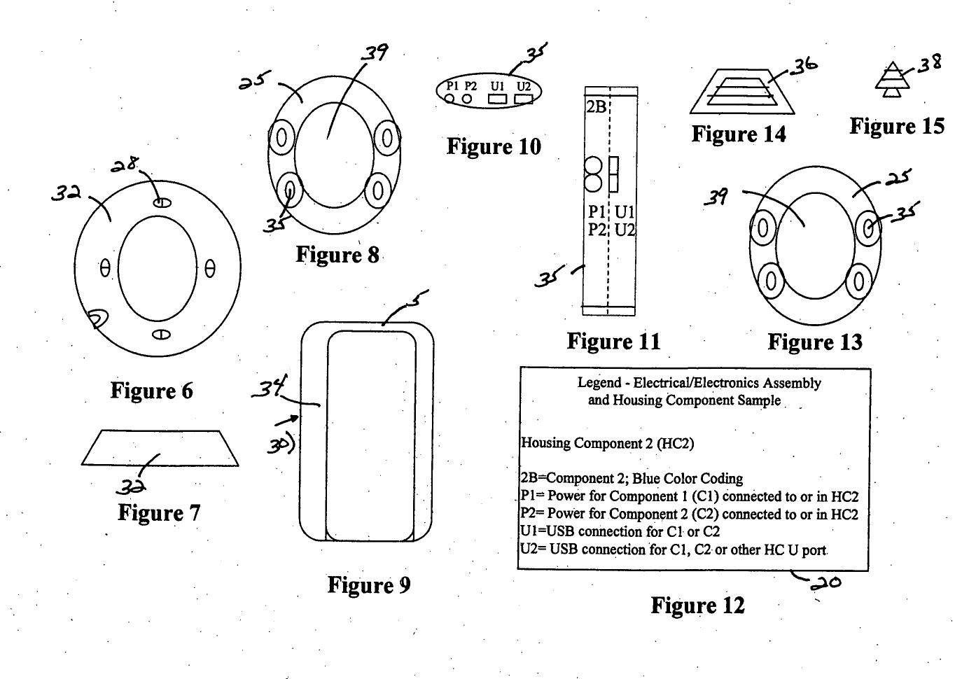

FIGS. 1 through 15 depict a present invention embodiment of an air purifier and air purifier enclosure system. Air purifier 1 has a main housing 3 with top 5 with controls 7 located thereon, an air filter ingress port area 9 and a treated air egress port area 11. Bottom 13 is adapted for and recives a lower base component 32 which is part of the multifunction-capable enclosure 30. Multifunction-capable enclosure 30 also may comprise a mid-component 34 with a top annular section 35. The term “multifunction-capable enclosure” is used herein broadly to include embodiments with structural functionalities such as, but not limited to, comprising telescoping means, as well as housing functionalities, such as, but not limited to, comprising electronics and a variety of other components, as well as providing operational support means for such components, such as, for example, powering means. Multifunction-capable enclosure 30 may have one or more interconnection components, pending on the modularity and applications associated with such air purifier and component system. It (enclosure 30) may be adapted to either be an integral component of an optimally configured air purifier product or system or fit existing air purifiers.

One of the major advantages of the present invention is to provide for, at minimum, optimal air purifier technology means to the end user, which, in some embodiments, may be configured by the end user, as well as, to utilize the numerous functions (air purifier and non-air purifier) that are available from a variety of electronics (including, but not limited to switches, processor-based and/or electrically powered) and communications products in a more adaptable, integrated and enhanced means with new utilities without the need for purchasing such products in an integrated system at one time or cluttering the living and work space with such items when purchased incrementally in standalone form. Optimal air purifier technology applications may differ amongst users as users needs differ. Air ionizers effectively remove many particulates such as bacteria, mold, dust, other allergens from the air, as well as ultra-fine particles of smoke, viruses and chemical fumes. High Efficiency Particulate Air Filters (HEPA) or filters capable of capturing 99.97% of particles as small as 0.3 microns are largely considered as being most effective for removing solid particles such as allergens. Filtering systems utilizing germicidal ultra-violet (UV) light are effective for destroying a large variety of microbial contaminates, such as viruses, germs, bacteria and fungi. Activated carbon air filters are highly effective for capturing and neutralizing chemicals, gases, odors and cigarette smoke. Ozone generators (though potentially harmful), when used prudently by the appropriated user group, may serve as odor eliminators when other means are not effective, as well as a close range powerful disenfectant. The means for providing a user or users with the preceding purifying capabilities, as well as a variety of other components (such as, but not limited to, from pre-filters for prolonging system filter to ionized oxygen generators), and future filtering, purifying and generator improvements and technologies, in an integrated and/or modular system in an incremental and economical manner supports a greater likelihood of use and derived benefits for the air purifier technology(ies) that is(are) most appropriate for the respective user or users. One of the means for providing such utilities is to incorporate such numerous functions in systems comprising at least one or more components adapted for being comprised, integrated, networked or connected of, in or with at least one air purifier, and in some preferred cases an integration of or network of such air purifier technologies and/or devices. Enclosure 30 and its associated components described herein support such integration for delivering the optimal and expandable configuration.

It is advantageous for such enclosure 30 to be associated with (a) modified air purifier or ionizer product(s) where such modified product(s) may have (an) electrical plug-in module(s) for the air purifier power component to allow for such purifier system to be turned on with a pre-designated setting without the need for manual operation (instead of existing products which require manual operation once an electrical current is broken). For purposes of the Figure illustrations, multifunction-capable enclosure 30 fits an existing air purifier. FIG. 5 depicts an enclosure 30 with a base component 32, a mid component 34, and top components 36 and 38. Enclosure 30 may also exist as one or be comprised of one or more enclosure component(s). For example, one invention version may consist of base 32, mid 34 and top 36 and 38 as one enclosure component and not as separate components as illustrated in these Figures. Both forms of enclosures may also comprise sectional and non-sectional embodiments and have their advantages pending on the air purifier system design and degree of modularity and air quality optimization the end user desires. Both forms may provide multiple utilities (which may be purifier and non-purifier related utilities) as noted, but not limited to, what is noted in this narrative associated with FIGS. 1 through 15.

The enclosures may have an outer portion comprised of a variety of materials such as, but not limited to, moldable plastic composites, pottery, clay, porcelain, ceramics and/or woods with a variety of finishes and possible inlays (such as precious minerals or woods). The inner and interconnecting portions of such enclosures may be comprised of plastic composite, processor-based and electrically conducting (such as copper) materials that are suitable for supporting each respective component's structure and functions.

Base component 32 may be in the form of a spherical or elliptical ring, (or rectangular, octagonal or square enclosure), pending on the design and form of the air purifier, with an inner open portion that is wide enough for sliding or bringing component 32 down to the bottom of the purifier base. Base 32 may also be comprised of sectionals, as well as telescoping means, to accommodate, for example, an expandable modular purifier system. It also has an aperture for surrounding the purifier electrical adapter and for supporting its structure to reside on top of and around the purifier base in a horizontal manner. Base 32 may be in a variety of shapes and forms, and may also comprise weighted components to support the associated configuration system. Base 32 may also have at least one processor, preferably modular and interchangeable, (or no processor) and interconnecting components to allow for modular electrical, data/device interfaces (such as, but not limited to, USB) and inter-fastening (among other forms of enclosure interconnection) connections to mid component 34 and electrical and/or user interface and/or processor and/or communications equipment connections to devices (modular or non-modular) within or external to the base.

Mid component 34 may be in the form of a spherical, elliptical, octagonal, rectangular or square cylinder with an inner open portion that is wide enough for surrounding most or all of the non-air flow components of the air purifier, as well as an open area 39 on its top 25 to expose controls 7 for easy access. Component 34 may also be in a variety of structural embodiments to support additional air-flow, purifying and filter components, as well as other configuration apparatuses. It may have at least one processor, preferably modular and interchangeable, (or no processor) and interconnecting components to allow for modular electrical, data/device interfaces (such as, but not limited to, from basic communications interface circuit connectors to USB interfaces) and inter-fastening (among other forms of enclosure interconnection) connections to base component 32 and top components 36 and 38 and electrical and/or user interface and/or processor and/or communications equipment connections. One of the means for providing the preceding electronics components and functionality may be provided in the present invention electronics and electrical housing component, such as housing component 35 depicted in FIGS. 8, 10, 11 and 13. Block diagram 20 of FIG. 12 illustrates one example of this housing component's electrical/electronics elements and assembly.

Top components 36 and 38 may function as inner module, processor, data and/or electrical connector, housing and/or purifier and console components. For example, component 36 may comprise (a) motion detector, a smoke detector, software, user interface, timer and/or wireless communications equipment (among other modular) components that may be utilized for non-purifier and/or purifier utilities such as activating and controlling the purifying settings and duration of the operation of the air purifier or purifier system. Component 36 may also comprise electrical and circuit connectors for such modules and mid component 34 connections. Component 38 may be an outer housing enclosure that may interconnect with the outer portion of mid component 34 and other top modular components. Such top components may be or comprise a lighting fixture, remote control receiver or a wireless data chip. Such networked components may be associated with a present invention radio frequency transmitter module residing in a present invention multi-utility urn fixture or a home ZigBee, Bluetooth or hybrid X10, Homeplug/ZigBee network. The use for integrated detectors and a timer for the present invention system supports a variety of utilities, such as, but not limited to, from activating a certain purifier unit for a certain time period (for example, a unit with an activated carbon air filter that becomes operational upon the detection of cigarette smoke and stays operational for a user selectable designated period of time). In another example, a modular timer embodiment for supporting a HEPA filter unit for a designated period of time at a certain time of day, may be integrated with such unit and also be integrated and optionally configurable to support an ionizer unit where one user of said unit may desire a designated periodic operational interval, while yet another user may prefer a 24/7 operational interval. A variety of wireless communications equipment may be supported in the present invention system, for example, from integrated wireless ZigBee™ equipment that may support a remote timer (which may support the example in the preceding sentence) or remote control application to non-integrated Wi Fi equipment that may utilize the infrastructure and location of the air purifier system as a repeater or hub means in a local area network. The ability to support a variety of components and functions, such as, but not limited to, those described herein, as the user desires delivers additional advantage to the users of the present invention system.

Health and Medication Support System:

In other embodiments of the present invention air purifier and enclosure system, such system may also be comprised in a present invention health system where such system and its components may support a variety of health and medication functions from enhancing the patient living or dwelling area (through, for example, said air purifier and enclosure system), to facilitating medication administration, patient monitoring, intervention, as well as the exchange of medication and patient information in an incremental and economical manner. With present health and medication support systems, uneconomical and inefficient duplicity result when the user has the need for utilizing multiple devices that incorporate like processing, communications, and reporting capabilities. In the other extreme, similar components also exist as part of an entire system without the capability of functioning as standalone components. As a system, these components may support economy of use, but may not be as affordable as users and/or health care entities and interests desire. For example, an integrated multi-functional telemedicine system may only be economically justified by in-home patients requiring daily comprehensive and/or nursing service care. Such telemedicine systems also require staffing support which may also prove to be uneconomical and may not be reimbursed by insurance providers.

In addition, systems and/or devices that facilitate more economical medicine and health aid administration do not support user-friendly and/or appropriate ergonomic interfaces for patients requiring such interfaces (for example, a senior patient who may not be accustomed to a PDA, or who may not have or has no desire to have a PC). There are a variety of medical devices or device aids that are economical and associated with optional accessories for facilitating care and feedback information. For example, a blood glucose meter may come with an alert function that is initiated when a reading is outside of a parameter range. In addition, PC software and an adapter interface may be utilized with such glucose meter for receiving, processing, storing and presenting meter readings for the end user. Though these aids are helpful, they may not be as beneficial to senior individuals who may not use a PC or others who may require more assistance or third party intervention. Often, family members, who are interested in the proper well being of their relatives and have a desire to help, are limited in providing care due to proximity, economic and time constraints.

It is an object of this invention to provide the means to facilitate medication compliance in a more user friendly and probable manner and support intervention in a means and manner that is more acceptable to the patient or end user. Such present invention system components may also be adapted to support the variety of end users and third parties associated with such user and medication compliance and health programs, where such users may be, but not limited to, in-home, assisted living, independent, or individuals residing in other facilities and/or institutions.

Finally, it is another object of this invention to incorporate some of its key components into a variety of other compliance or transaction processes, devices and/or systems (including, but not limited to, those associated with medical, industrial, commercial, waste disposal, safety, security and/or authenticity applications) that utilize or may be adapted to utilize information recognition input means such as, but not limited to, one or more of the following coded data readers which is/are adapted for the present invention system: bar code readers (such as linear bar codes and two-dimensional bar codes); radio frequency identification (RFID) technology readers; printed data encoding technology readers; magnetic stripe, tape or storage readers; optical hologram readers; Optical Character Recognition (OCR) readers; and DNA-mark readers, where such present invention system key components support increased efficiencies and utilities in the application and use of such information recognition coded data input components. It is to be appreciated that the term “coded data” is used herein broadly to include bar code(s), such as, but not limited to linear bar code(s) and two-dimensional bar code(s); printed coded data; coded DNA-mark(s); coded chemical mark(s); stored readable data such as, but not limited to, magnetic stripe or tape; holographic data; optical character recognition data; and other coded technologies and/or means,

The medical and health application embodiments of the present invention account for a system that comprises: a main device and/or at least one or more medical device components or apparatuses and/or interfaces; and wired and/or wireless interfaces and components where such components may be available as integrated and/or standalone units. As integrated components, they may be integrated with such main device where such main device may provide the means for, at minimum, a communications capability and/or communications interface and/or a central processing and/or a central reporting capability. As standalone components, they may be initially purchased as such and subsequently integrated with a main device having, at minimum, the preceding capabilities. The present invention main device and peripheral components may also comprise or be associated with a variety of information recognition input components such as readers where said input devices are adapted with alignment indicia to facilitate the capture of coded data, especially when said reader alignment indicia is associated with like or similar indicia that may be marked on the item being read. It is to be appreciated that such alignment indicia components have broad applications within and outside of the health and medical fields and industries for facilitating the capture of coded data. The present invention may also comprise (a) server-based (onsite and/or remote) component(s) to support the following: 1) remote party administration and intervention in medication and medical device use, as well as medical device programming; 2) authorized third party medication regimen and patient health inquiry, regimen prescription downloading and ordering; and 3) a variety of reporting and information presentation capabilities.

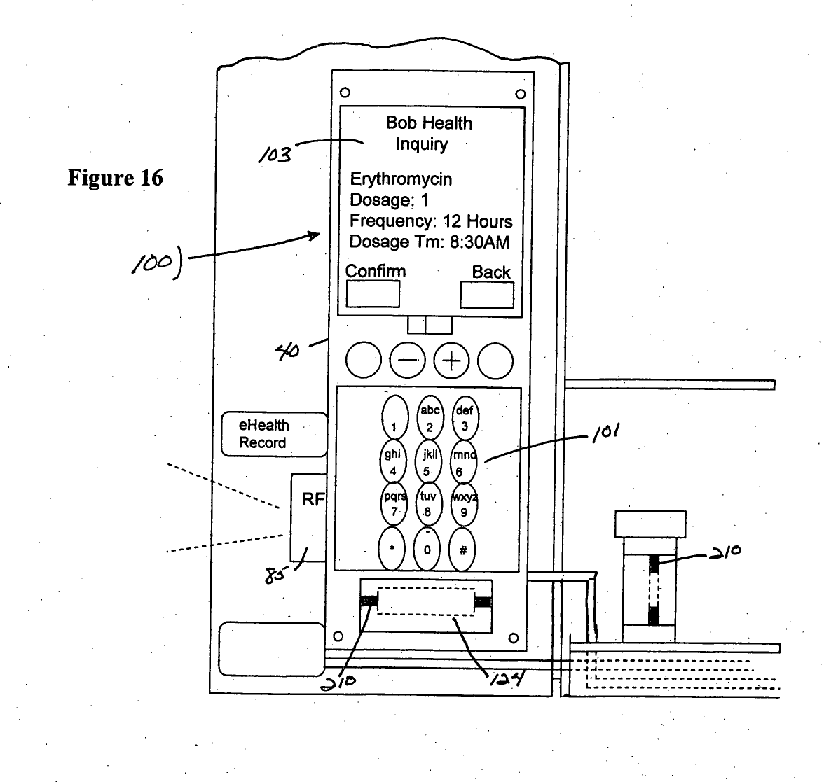

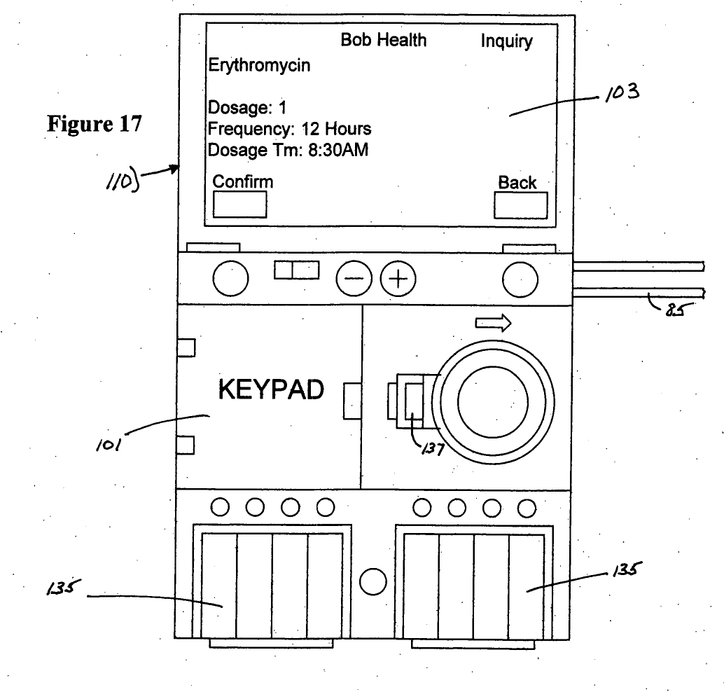

With reference to the illustrations of FIGS. 16 through 23, a main device 100 and a main device 110 may account for the following: facilitating medication administration, supporting third party communications and comprising one or more means to support connectivity for a medication aid device and/or medical device monitoring and/or functions. The main device may be in stationary (mounted) form, device 100 (FIG. 16), or in portable form, device 110 (FIG. 17), and support code scanning/reader/input (such as, but not limited to, bar code, RFID, printed data encoding technology, magnetic stripe or tape, OCR, optical holograms, and/or DNA-marking) functionality.

Main device 100 and main device 110 may consist of the following components:

five categories of input components: wired and/or wireless (including RFID), coded data readers or scanners (as previously noted, the term “coded data” is used herein broadly to include bar code(s), such as, but not limited to linear bar code(s) and two-dimensional bar code(s); printed coded data; coded DNA-mark(s); coded chemical mark(s); stored readable data such as, but not limited to, magnetic stripe or tape; holographic data; optical character recognition data; and other coded means), button activated, and/or voice activated.

four categories of output components: wired and/or wireless transmission and connectivity, audible and/or visual output means (it is to be appreciated that such output connectivity may be associated with a peripheral device where such device may generate an output that may be at least one of the preceding and/or other output function(s), such as a vibratory output).

processing, device driver and menu-driven software to facilitate user interaction; medication administration and ordering; medication device information, functionality, operation, and inquiry; and alert, notification, reporting and communications functions

device adapters, as required, to support connectivity to a main device docking station 40 and/or medical devices and/or medical device interfaces (wired and/or wireless) such as, but not limited to, a portable storage device that may include patient information and program backup, a blood meter, a blood pressure device, an infusion device, a biometric device, an oxygen tank or concentrator, medication dispensers and/or holders and/or scale devices, sharps container and information system, and/or at least one biosensor.

other integrated components such as, but not limited to, a bar code reader and/or pill compartments and associated timer and components.

Input Components:

The five types of input components are wired, wireless, coded data readers or scanners, button-activated or voice-activated. They may exist in separate or combined forms.

The wired input application component may consist of a communications interface cord, cable (such as, but not limited to, a USB—Universal Serial Bus cable), circuit or device connectors (that may support standard communications and electronics protocols and interfaces). The input sources may be, but not limited to, medical and/or medical aid devices; and/or communications devices such as a modem or Ethernet interface to link with a variety of wired network mediums; a personal, pocket, tablet or PDA computer; an external memory device; a Digital Satellite Receiver and/or a digital radio receiver (for the purpose of enhancing the user experience by receiving general news that could be displayed on such main device display); a cable box unit; a paging receiver; and/or electrical circuit connections to motion detectors, line-of-sight optical detectors, infra-red coded readers, lock box components, sharps dispenser components, and/or medication dispensers/holders components such as, but not limited to, lids, latches and/or springs.

The wireless input embodiment may be associated with general radio spectrum frequencies for local area and wide area networked devices, from low spectrum RF devices, mid spectrum networked devices such as ZigBee™ equipped or connected devices, higher spectrum Bluetooth and/or Wi Fi equipped or connected devices, UWB (ultra wide band) devices, cellular devices, RFID receivers, AM and FM, as well as emergency weather and All Hazards band frequencies, Digital Satellite Radio and/or digital radio receivers (where some of the preceding enhance the user experience by supporting news of interest to the end user). As noted, such devices may be adapted for various platforms and/or protocols such as, but not limited to, Blue Tooth, Wi Fi platforms, UWB, ZigBee, and/or proprietary closed standards-based wireless protocols. This embodiment component may be in the form of, but not limited to, a network transmitter and receiver card and/or chip set, processor and device interface with the appropriate software and/or firmware. Another wireless input component may be an infra-red assembly.

The coded data input application may consist of a scanner, reader or receiver such as, but not limited to, a bar code reader; radio frequency identification device (RFID) receiver; printed data encoding technology reader; magnetic stripe, tape or storage reader; optical hologram reader; Optical Character Recognition scanner/reader; and/or a DNA-mark reader. The scanning function may be associated with, but not limited to, reading medication or vitamin label information, or receiving RFID information from a variety of embodiments such as, but not limited to, tag cap, vial, and container medication information, as well as reading other RIFD tags that may present exceptions to medication regimens or patient welfare, such as cigarette packages with RFID tags.

The button-activated input utilizes either keypad 101 or a display button. The voice-activated input may utilize a variety of voice recognition chip sets with associated storage and software means. The five preceding components may be embodied in (and)/or interfaced to the main device.

Output Components:

The four types of output components are wired, wireless, visual and audible. These components may also exist in separate or combined forms.

The wired output application component may consist of a communications interface cord, cable (such as, but not limited to, a USB—Universal Serial Bus cable), circuit or device connectors (that may support standard and/or proprietary and/or private communications and electronics protocols and interfaces). The output sources may be, but not limited to, medical and/or medical aid devices; communications devices such as a modem or Ethernet interface; a personal, pocket, tablet or PDA computer; an external memory device; a server; a cable box unit adapted for displaying personalized or local area device networked content (including the present invention main device content described herein) and/or electrical circuit connections to lock box components, sharps dispenser components, and/or medication dispensers/holders components such as, but not limited to, lids, latches and/or springs. The wired output application may also be associated with local area and wide area networked remote alert devices.

The wireless output application component may be associated with the same or similar devices related to the wireless input application component. The wireless output application may also be associated with local area and wide area networked remote alert devices

The visual output application component may be, but is not limited to, a display 103 on the main devices 100 and 110; a display on a television, cell phone, computer and/or other portable devices associated with the patient or third parties; a lighting element such as, but not limited to, a bulb or LED on the main device or on other embodiments such as, but not limited to, on medical or medicine devices that are connected (hardwired, circuit means, wired or wireless communications means) to such main device or even on a cabinet door that is associated with a medicine cabinet.

The audible output application component may be in a variety of embodiments such as, but is not limited to, a chirping device (or similar sound emitting device), (a) programmed phone call(s), a speaker apparatus which may be connected to main devices 100 and 110 through a wired or wireless means, and/or programmed reminder message(s)/alert to the patient and/or alert messaging to third parties. As noted, the preceding output components may be embodied in the main device or interfaced to the main device, and/or interfaced to other devices associated with the main device.

Software:

The main devices 100 and 110, each account for processing, device driver, administration and menu-driven software to facilitate user interaction, medication administration, prescription information, medication ordering, medication device information and functionality, inquiry; and alert, notification, reporting, intervention and communications functions

The processing software function comprises programs that may be initiated by data from primarily input sources and time/date parameters. Data from input sources may be, but is not limited to, scanned bar code information from a prescription label, a glucose level reading from a blood sugar meter, transmitted gas mix exception levels from an oxygen concentrator, and/or transmitted prescription information from a pharmacist or physician. Time/date parameters may be based on two types of metrics: time/date clock and time cycles or intervals.

Device driver software is primarily for controlling external device functions. Examples of such functions may be, but not limited to, activating a circuit lead to unlatch a lid on a medication holder associated with a pill dosage compartment and/or activating a bar code scanner that may be mounted to the inside of a medicine cabinet, where upon the opening of the cabinet door, a circuit switch that is connected to such bar code reader activates such reader for a certain period of time where such circuit switch activation may originate from an activated motion detector inside the cabinet facing such cabinet door.

The menu-driven software provides the user interface means for the following main functions: medication administration, medication device information and functionality, inquiry; and alert, notification, reporting, intervention and communications functionality. This software may be in the form of text/list-based menu driven functionality and icon-based drop-down menu and/or pop-up functionality.

FIGS. 16 through 23 depict sample sequences associated with the present invention menu-driven software.

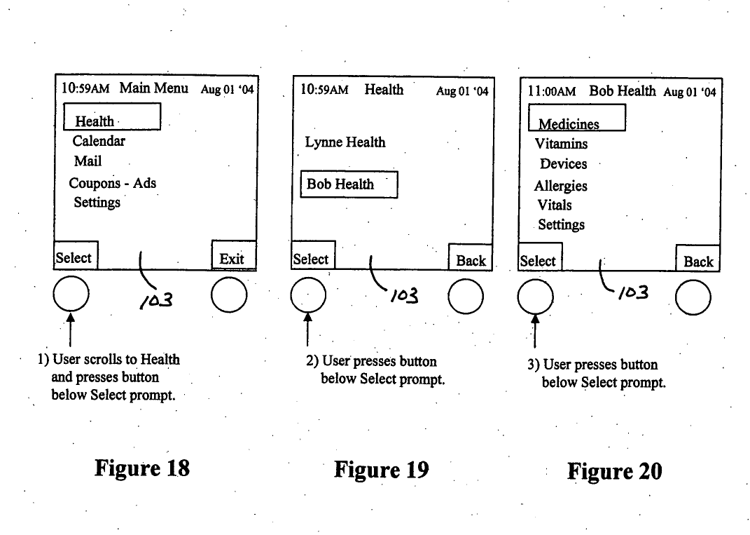

FIG. 18 illustrates a sample main menu display showing time, date, the words, “Health”, “Calendar”, “Mail”, “Coupons-Ads”, and “Settings” in the main portion of the display, and the words, “Select” and “Exit” on the lower left and lower right, respectively, portions of the display. Upon depressing a scrolling button on the main device, the words, such as but not limited to, “Directory”, “Games”, “Questionnaire” and “Other” may also appear on the display. Pending on the expansion module associated with the main device, a “Phone” text may also appear on the display.

Upon depressing a button below the “Select” term when the cursor is over the word, “Health”, the user names associated with the present invention system appear on the display, such as, “Lynne Health” and “Bob Health”, as depicted in FIG. 15. After depressing the button below the “Select” term when the cursor is over the word, “Bob Health”, the following words may appear on the display below the header, “Bob Health”, “Medicines”, “Vitamins”, “Devices”, “Allergies” and “Settings”, as illustrated in FIG. 20.

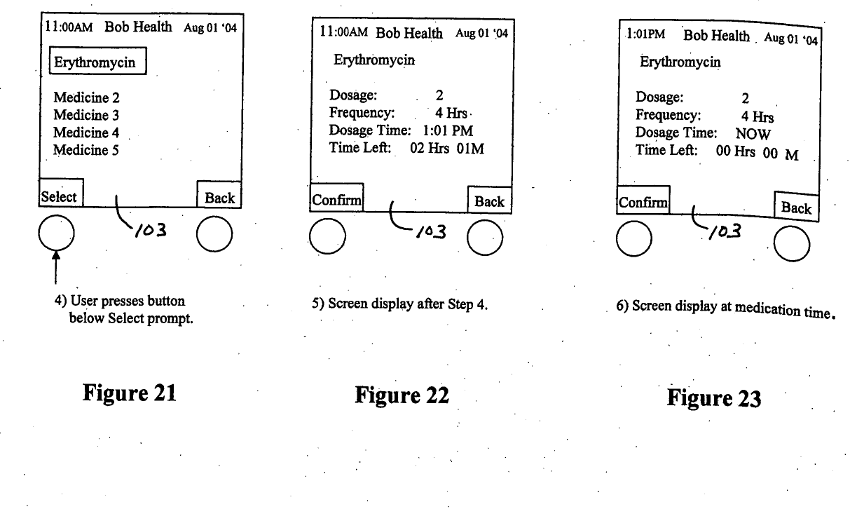

FIG. 21 illustrates the display readings upon depressing the button below the word, “Select” when the cursor is over the word, “Medicines”. The fields, “Erythromicyn”, “Medicine 2”, “Medicine 3”, “Medicine 4”, and “Medicine 5” may appear on the display under the header, “Bob Health”. Scrolling may enable the user to see more medicines.

FIG. 22 depicts the display readings of “Erythromicyn”, “Dosage: 2”, “Frequency: 4 Hrs”, “Dosage Time: 1:01 PM”, “Time Left: 02:01” which are activated after depressing the button below the word, “Select” from the preceding screen (FIG. 21).

FIG. 22 also depicts the words, “Confirm” and “Back” on the respective lower left and lower right portions of the display. The “Confirm” prompt is associated with the confirmation of the user taking a medication. Even though the user may have 2 hours and 1 minute left before the next dosage, the “Confirm” prompt may appear. An alternative prompt associated with a medication dosage that is not due may be “Next” for purposes of scrolling to the next medication readout. Should the user depress the button under the “Confirm” prompt, the main device may emit a warning sequence of two chirps and display a text question such as, “Did you take erythromicyn?” along with the prompts “Yes” and “No” at the lower left and lower right portions of the display. Separate questionnaire and activation sequences may take place pending on the medication, dosage and dosage time associated with such medication.

FIG. 23 depicts a display sequence when it is time for a dosage. The terms, “Dosage Time: NOW” and “Time Left: 00:00”, along with “Confirm” and “Back” on the respective lower left and lower right portions of the display may appear with this type of sequence.

Upon depressing the button below the term, “Confirm”, the next screen may display, at minimum, the term, “Take erythromicyn pill 1” with a “Confirm” or similar prompt on the lower left portion of the display. Upon depressing the button below the confirm prompt, the screen may display, at minimum, the term, “Take erythromicyn pill 2” with a “Confirm” or similar prompt on the lower left portion of the display. Upon depressing the button below the term, “Confirm”, the next screen may display the sequence illustrated in FIG. 22, with two exceptions. The exceptions may be displayed as “Dosage Time: 5:02 PM” and “Time Left: 4:00”.

One of the embodiments of the present invention system is at least one program that displays a certain screen sequence based on a set of one or more identifiers or modes. These identifiers or modes may be, but not limited to a date and/or time metric, a dosage time metric, and/or an email originating and/or subject header and/or attachment name or code.

One example of the use of the preceding invention embodiment is a program that displays a text message, “Call Doctor for Results” and emits one or more chirps on a cycled interval that may indicate the user that the display is in a message board mode based on a preprogrammed time and or date. Another variation of this message board function may be displaying an email or text message that includes the test results based on a program that screens one or more of the following identifiers: email originator, subject, message text words, and/or attachment file name, where such program is based on the activation of an interval cycled program that enables the device to automatically call out and log on to a server for messages. With the latter identifier of an attachment file name, an attachment may be opened and displayed, upon the appropriate matching with other identifiers.

Another component function of this present invention embodiment may be displaying a digital photo, given that such display (such as, but not limited to, a LCD), driver and program supports such functionality when an email or message is received with the appropriate identifiers. An application for such present invention embodiment is automatically displaying a digital picture of, for example, a user's grandchild that may have been taken at the beach and sent or forwarded to the main device email or network address. Another embodiment of this present invention device is to display an accompanying email message or play an audio portion of the message, if such device comprises appropriate audio components and software, such as the software provided by Real Networks, Inc., having an address at 2601 Elliott Avenue, Seattle, Wash. 98121.

This example may work through the use of the following present invention embodiment components: a communications interface and component such as, but not limited to: a modem, a Wi Fi card and/or a ZigBee™ chip set and interface or a broadband interface; a communications program or software component such as, but not limited to, an email application program or a browser; a timer or clock cycle program (programs may vary pending on the communications applications); a screening (identifier or mode) program and associated screening match table and/or like component; at least one device driver program; a user interface and associated program(s) and at least one executable program. The automatic networking component associated with the embodiment described herein accounts for, but is not limited to, utilizing a modem as the communications interface. In this configuration, the user may designate a cycle interval in which the main device modem may dial out to the user's internet service provider portal or the present invention server. Upon the modem accessing either portal, and transferring associated login and password information, the main device program may launch the email access, screening, opening and displaying function based on the execution of prescriptive identifiers and tables associated with such function.

The purpose for incorporating the digital picture function as an option to this type of present invention embodiment is to account for uses for engaging user interaction, enjoyment and use of the system. Other incentives for the use of this system may be, but are not limited to, advertising, coupons, games, questionnaires, and/or news reports which may be adapted to the main device display and other mediums associated with the patient or system user or associates related to the patient/system user.

Another example of the present invention identifier or mode program embodiment is utilizing a dosage time identifier. In this application, the main device display may include the prompt, “Dosage Time: Now”, upon the activation of a dosage time identifier program which accounts for displaying the preceding message associated with a certain medication at a specified time and/or dosage interval. The dosage time identifier program may have a number of other functions, such as, but not limited to, playing a voice message when it is time for a certain medication and the type and dosage for such medication where such voice messaging component may reside within the main device or the pertinent present invention networked bottle cap or bottle cap top. In addition, such program may also comprise a function such as, but not limited to, activating a lighting component that may be on a pill box compartment or prescription bottle cap associated with such medication.

Integrated and/or Networked Components:

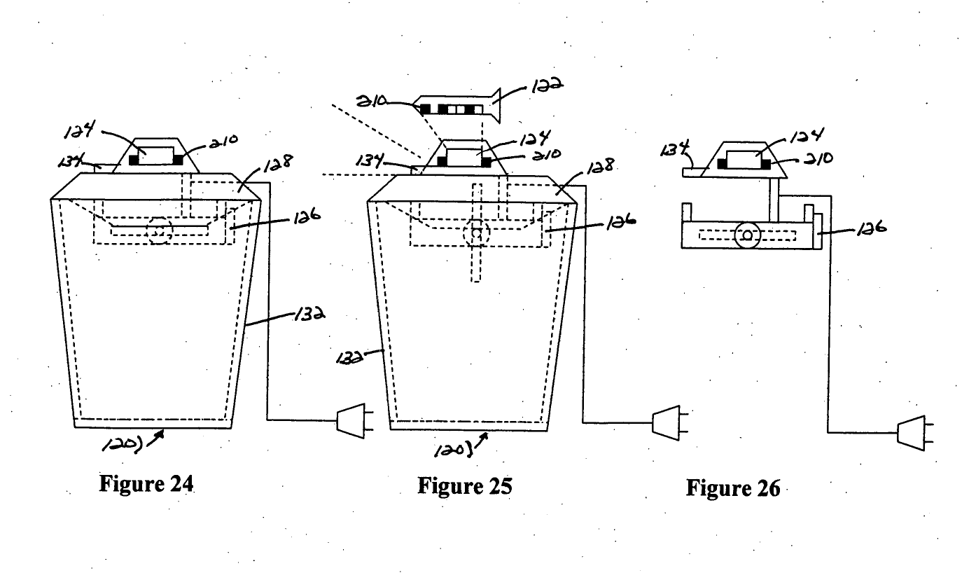

Another such present invention embodiment that may enhance main devices 100 and 110's medicine administration functionality is shown in FIGS. 24, 25 and 26, and is a dispenser material tracking and medication aid system 120. This system 120 is comprised of a coded data reader, such as, but not limited to, the reader and associated embodiments previously described herein, for example, a bar code reader 124 RFID tag reader, and/or an Optical Character Recognition Reader (OCR); at least one line of sight scanner 126; a dispenser cover 128 which may come in a variety of embodiments; a dispenser container and/or a dispenser container enclosure 132; at least one communications component 134 and a variety of materials, containers, components, packaging and/or vials 122 that have a coding means for enabling a coding reader and/or scanner to register such coded information. The preceding invention components and associated components described herein are comprised of materials suitable for supporting each component's respective structures and functions. The reader(s) 124, RFID and/or OCR, scanner 126, and other related signal or scanning embodiments described herein are comprised of metallic, processor, hard plastic composites, electrically conducting and precious mineral materials. The dispenser cover may be comprised of a moldable plastic composite and may comprise a metallic or durable plastic mounting plate and locking component (locking component may not be in all embodiments), and metallic and electrically conducting components associated with the invention embodiments described herein. The dispenser container and/or dispenser container enclosures may be comprised of a moldable plastic composite, as well as metallic or durable plastic locking mechanisms pending on the type of present invention embodiment. The vial may be comprised of a moldable and partially translucent plastic composite. The system 120 is a part of other embodiments of the present invention that may be associated with or part of, in whole or in part, a health records recording and reporting system and service, a notification and alert system and service, and a health management and health management provider system and service.

The dispenser material tracking system has many embodiments and supports many applications, such as, but not limited to, from document shredding to toxic and/or radioactive material dispensing to spent health and/or medical material dispensing in a variety of facilities, such as but not limited to, residential, institutional (such as, but not limited to, hospitals, drug clinics), and/or assisted living dwellings. A significant benefit that has been and will continue to be addressed in this invention narrative and illustration is for aiding many types of patients and people in administering a variety of medications. One form, of many forms that may be accommodated by the present invention, is a disposable syringe.

One present invention embodiment, a disposable syringe container or vial 122, may support accounting for information by having the means, such as, for example, a surface area to accommodate (a) coded data packet(s) such as, but not limited to, a bar code or character label or a means for accommodating a RFID component. A coded data reader 124, RFID, and/or OCR that may be integrated or interconnected with a recording function and the optional or integrated operation of opening a closed aperture on a dispenser cover 128 or the side of a dispenser container or dispenser container enclosure 132 along with at least one communications component 134 are other present invention embodiments associated with vial 122.

One embodiment of vial 122 comprises a bar code plate surface and/or label. Such bar code may contain information such as, but not limited to, the type of medication and dosage amounts and frequency. The bar code reader 124 may be secured on the top of the dispenser cover facing in front of a recessed aperture. Such aperture may have a door and door like mechanism that may be closed. The coded data reader 124 processor may be connected to an electrical circuit contact, amongst other contacts, where upon confirmation of an accurate read, an electrical connection is made over such circuit which results in activating a mechanism, such as, but not limited to, to pull a latch (that may be connected to a spring mechanism) for opening the aperture door. The reader processor or interconnected processor may also have a date and time function and be interconnected to a memory means for recording the scanned information and date and time of such scanning. In addition, such reader processor and/or memory means may be linked to a communications interface and/or chip, such as, but not limited to, a ZigBee™ chip set, for communicating such information to a main device, and/or third party devices and/or a service.

One of the intentions of such system 120, along with the other present invention devices, is to provide the end user and other constituents a tracking means for taking a prescribed medication in a manner that conforms with the process of taking such medication. Given that a user may have a medical condition requiring an injection of a medication through the means of a disposable syringe, and such syringe is disposed in a container solely for such purpose, the placement of such reader 124, RFID, and/or OCR on or around such container provides minimal interference with the existing process. The two interference points of having the vial scanned (by a bar code reader or with a RFID tag reader or other coded data means and reader that may support less of an interference factor) and discarding the vial in the dispenser upon the opening of the aperture door are mitigated in comparison to the benefits derived for such points. In one embodiment, the vial may be dropped in a recessed aperture; however, it is recommended, pending on the embodiment, that the user should ensure that the aperture door is opened and such vial is dropped into the dispenser. In instances where a bar code, RFID tag or other coded data means is not supported for an injectable or subcutaneous application, a line of sight scanner 126 facing the aperture of the container for, at minimum, capturing the disposal of each disposable needle or application and the time and date of such disposal adds value for the user or service that desires a more accurate and unencumbered tracking means.

The benefits of providing a tracking function to support administering medicine allow the user, care provider, and/or relative to know, at minimum, when the last dosage may have been taken. Given that such information is recorded, the present invention, as noted, has a number of embodiments for processing and presenting such recorded information.

One embodiment comprises a processor with a program for processing the medication type, the dosage, and frequency information by the reader 124, RFID, OCR, and/or other coded data readers or scanners and date and time associated with the activation of such reader(s) for capturing the vial barcode, RFID tag, character information, and/or other form or embodiment of coded data. A sample program may be to register the following in a field of characters: a variable, A, when the code identifying a drug, such as beta seron, is scanned by the reader; a number that is equal to the dosage amount number scanned by the reader; another number that is equal to the hourly interval number scanned by the reader; and another number that is equal to the day counter interval scanned by the reader. The processor may have a program for each unique medication. Additional information, which may be coded and associated with a different program, may be the package number, quantity count, and expiration date associated with such package that the medicine may be associated with. Given the preceding information, the present invention may comprise a program that has a counter, alert, reminder and/or ordering function associated with the medication package that may be activated when a program counter quantity reaches a certain threshold.

A sample present invention program for administering a drug such as beta serone may be program A that may consist of the following program lines and logic flows. Such medication program and logic flows become activated each instance the reader 124, RFID, OCR and/or other code data reader scans the coded medication information associated with such medication. Line 10 may assign character values for each respective code value scanned by such reader 124 or other coded data reader such as, U=12 (for assigning the value 12, which may equate to the drug, beta seron, for medication character U), V=01 (for assigning the value 01 for dosage character V), W=00 (for assigning the value 00 for hourly character W), and X=02 (for assigning the value 02 for the day counter character X). Line 20 records the run date that program A was activated and assigns the date character D with such run date, for example, D=040220, for the date of Feb. 20, 2004. Line 30 records the run time that program A was activated and assigns the time character T with such run time, for example, T=0830, for the time of 8:30 AM. Line 40 may have an IF THEN statement for setting program flows based on dosage information such as, IF V=01, line 60, for running a program flow that starts at line 60 if the value of V is 01. If the value of V is not 01, then the program defaults to the next line 50, which may be a GO TO statement for running a program flow that starts at, for example, line 200, such as, GO TO 200. Line 60 may set a counter value of 1 for a variable Y such as, Y=Y+1, for the purpose of supporting the logic for measuring an over dose condition. Line 65 measures for such overdose condition, such as, IF Y>V, GO TO 300. Line 300 may initiate a program or series of programs and alert actions associated with the overdose condition. Line 70 may deliver a command to restart the program A on line 90 when the date and time is Feb. 22, 2004 at 8:30 AM, such as RESTART line 90 IF D=line 20+X AND T=line 30+W. Line 80 may be a program STOP command. The program A may be initiated when the user administers another dosage and utilizes the activation of coded data reader 124 and/or reader 126 as part of the medication administration process. The program A may also be initiated based on a date and time RESTART command such as the command associated with line 90. Line 90 may be a DISPLAY command such as, DISPLAY “BETA SERONE OVERDUE BY” AND T=T-line 30 AND S=D-line 20 +X to display the following on a display, such as, for example a LCD that may be interconnected (through a variety of means) to the program processor: BETA SERONE OVERDUE BY 1 HR 45M & 0 DAYS to notify the reader of the LCD display that the user may be over due in taking a beta serone medication by one hour and forty-five minutes and zero days. Line 100 may be an AUDIO command to activate an audio device that may be defined as CHIRP that is interconnected to a program processor, such as AUDIO CHIRP, which may activate the device and/or device processor that may have a program or electrical circuit that activates a chirp sound from such audio device. The remaining program lines in this program set that is associated with a one dosage medication (V=01) may account for other alert commands such as EMAIL, TEXT (message), PAGE and/or CALL an individual (BOB CELL) from a names directory, and/or group of individuals (FAMILY 1) from a list directory with a particular message which may reside on a primary processor or interconnected processor (MESSAGE 1). An example of such a command program may be on line 110 such as, IF T=line 30+W+01, CALL BOB CELL. Another set of commands may comprise a counter and loop function such as: line 140 may be, COUNT T @ 15 M; line 150 may be, CALL KATHY CELL; line 160 may be, CALL FAMILY 1; and line 170 may be, GO TO 140. This latter set of present invention program functions may be associated with a reminder and medical health alert system.

The preceding program illustration is one example of the various present invention programs, such as, but not limited to, inquiry and ordering programs and related invention component and services embodiments that may be associated with the present invention.

A related invention embodiment accounts for incorporating the preceding medical application dispenser material tracking system into a portable system, such as, but not limited to, a travel case and/or dispenser container and/or enclosure with the associated scanner device with at least one processor, memory and a combination of, but not limited to, all or some of the following components in a standalone (one device such as a portable main device) or interconnected form (such as being comprised in a handheld system such as a main device comprising the invention embodiments disclosed herein): display; alert capability(ies) (various audio and/or silent means); communications capability (such as, but not limited to, a wireless local area network and/or wide area network interface(s) and means); and external device linkage (such as, but not limited to, a USB connection and/or wireless connection). The portable system components may be comprised of materials suitable for their respective structures and functions such as, but not limited to, a hard moldable plastic composite for the vial container portion of the travel kit. The handheld reader and program processing device may be comprised of metallic, processor-based, hard plastic composites, electrically conducting and precious mineral materials.

Another invention embodiment expands upon the invention coding embodiments and accounts for such coding on all medicine and vitamin containers and packets (in comparison to utilizing prescription bar coding for hospital use). The purpose for such invention embodiment is to provide greater utility to the administration, management, compliance and intervention (as required) associated with taking medications, vitamins and other regimented practices. When coupled with a variety of invention device and device hardware and software components along with invention services or methods associated with such embodiments, in whole or in part, the present invention coding embodiment provides multiple utilities and benefits in health, preventative health care, and other fields and industries.

One coding system embodiment is to utilize bar coding (from a variety of coding sets or standards such as, but not limited to, linear bar codes and/or two dimensional bar codes) and bar code labels on the medicine or vitamin container that comprise information similar to the previously disclosed information herein. This invention embodiment may account for other information, such as, but not limited to, an expiration date. An embodiment that may be separate or be within this embodiment is a bar code label or imprint that consists of at least two information fields. One field of information is the bar code sequence. The other field of information may be a scan guide or alignment indicia 210 (FIGS. 16, 17, 24, 25, 26 and 27). The scan guide or alignment indicia 210 is a means for providing the user an indicator for aligning the appropriate coded data embodiment, such as, but not limited to, a label, mark, chip set, chemical mark, and/or transmitter in front of the associated scanner, reader and/or transceiver. An invention embodiment example of such guide may comprise a color marking or Braille block in a circular, spherical, rectangular, square or octagonal form with the words, “SCAN” or similar term or sign, printed or raised in such marking. It (210) may also account for at least one line or imprint that is on the opposite side or on one or more sides of a container to support the optimal means for aligning or positioning such container data code with the associated scanner. Scan guide 210 may be a color mark that is distinguishably prominent from the other colors on such label yet it does not impede one from reading the print on a label when such color mark bisects or runs through label print. An example of such color mark may be a yellow line that is wide enough for the user to notice and may be at a width comparable to a bar code width that is on the opposite side or quadrant corner of the container. The present invention embodiment coded data reader 124 may also have a line and/or Braille mark to facilitate the user with aligning a bottle label mark along with the mark located on such reader. An example of the deployment of such bottle label mark may take place at a local pharmacy where the pharmacy receives a mostly blank prescription label with a line mark 210 running down its center. Upon filling a prescription, the prescription label is printed with the requisite information. The label embodiment associated with this example may be comprised of primarily paper and adhesive (such as, but not limited to glue) composites. Part of this information may also be printed in coded data form such as, but not limited to, bar code either on the same label, pending on the size of the container that the label will be placed on, or on a separate label that is used solely for bar coding. Such invention embodiment mark may also be associated with other containers such as syringe vials and non-medical products, such as, but not limited to, from packaged goods to cans to containers for storing toxic and/or radioactive chemicals.

As previously noted, other invention embodiments may utilize such coding information on and for a variety of means and applications such as, but not limited to, other labels, tags or marks adapted for optical character recognition, RFID, hologram identification, DNA-mark identification, and/or chemical mark identification.

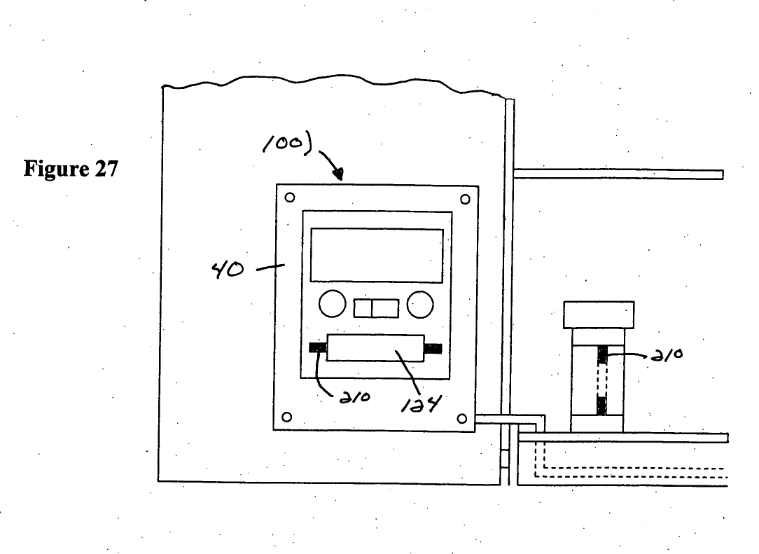

Another set of invention embodiments accounts for devices and associated equipment that facilitate the use of capturing such coded information through a means that supports the process for administering such medication and vitamins. An example of such embodiment is illustrated in FIGS. 16 and 27, where a coded data reader such as, but not limited to, a bar code reader 124 is secured in a reader mount and/or other associated equipment and/or components that may be mounted and/or adhered to, but not limited to, a cabinet door, preferably the inside of such door. As the user removes a medicine or vitamin container or packet from the shelf of such cabinet, the user may scan such container in front of (as associated with a bar code or OCR reader) or near (as associated with a RFID tag reader, where such proximity point may also be marked with alignment indicia 210) the coded data reader 124 or other present invention coded data reader.

The coded data reader 124 (or other present invention coded data reader) may be connected to a processor that may have a variety of programs such as those noted in this narrative, but not limited to such programs noted in this narrative, or may be connected to a set of processors with such programs. As previously stated, it is to be appreciated that the reference regarding processor and electrical connections, throughout this narrative and present invention text described herein, may account for wired and/or wireless connections. A present invention embodiment of such processor linkage may be not only a cabinet display, such as previously noted, but not limited to, a LED display or LCD, with text, icons and/or a color scheme to remind the user of taking other vitamins or medications, but such reminder information may also be displayed on a television, computer, PDA, or cell phone screen (which may belong to such user and/or (a) party(ies) associated with the user or a trigger condition, pending on the criticality of such information).

Another present invention embodiment of facilitating the process for medication regimen is a main device as described herein that incorporates at least one or more of the following: a pill box container 135 (FIG. 17), and/or another scanning means 137 embodiment (FIG. 17).

The pill box container may comprise at least one or more pill compartments and may also contain a means for informing the user about the relevance of each respective compartment and/or the medication regimen sequence associated with each compartment. This means may range from, but is not limited to, accounting for basic day or time of day markings, to comprising a lighting component, such as, but not limited to, a LED in proximity to each compartment which is activated at the appropriate regimen time, to comprising a locking means for all compartments and locking such compartments except for the compartment associated with the appropriate medication regimen sequence, to opening a latch associated with the appropriate compartment through, for example, a spring loaded mechanixm supporting the opening and closing of such latch or door associated with each compartment.

The present invention scanning means 137 embodiment may comprise the following: a recessed aperture with a depth and width for accommodating a variety of prescription, medication and/or vitamin bottles, an aperture bottom which rotates and may have alignment markings to facilitate the placement of a bottle, a rotating mechanism and/or means such as a motor for rotating the aperture bottom, a scanning component (such as, but not limited to, an infrared bar code scanning component), and at least one program software component for enabling the scanning, capturing and execution of present invention device functions associated with the scanning of such coded information.

FIG. 17 is an illustration of this main device 110 embodiment, though it may be available in a variety of other embodiments. It may comprise all of the forms of input, output, processing, and communications components as previously described in the text.

The pill box container 135 may be made of a durable moldable plastic composite with associated low cost plastic compartments and low cost plastic or metallic compartment assemblies, pending on the level of functionality, such as, but not limited to, hinged or spring loaded compartment lids, latches or doors. It may be removed from the main device 110 through a variety of means, such as sliding out of the main device 110 frame or docking connection. FIG. 17 also depicts a docking release button to facilitate this function. It may also comprise electrical contacts that are connected to a main device 110 circuit which is connected to a main device 110 processor for enabling pill box compartment level functions as previously described herein. It may also comprise data communications contacts with similar terminations as described in the preceding to facilitate higher level functionality such as interactive utility (for functions like medication regimen confirmation).

The scanning means 137 may be integrated in the main device 110 frame, or it may be an adjunct device to main device 110. It may be comprised primarily from a low cost moldable plastic composite for its outer and inner sides, its top and bottom portions and associated fasteners; and a combination of electrically conducting, metallic and plastic materials for its motor apparatus and infra-red (IR) reader/detector and amplifier.

The scanning means 137 IR detector may be in an on-state and its associated software program and motor may be initialized upon the placement of a prescription bottle in the recessed aperture and on its inner bottom planar surface. Upon this action, the detector may initialize a software program to cause the activation of the device motor to rotate the inner bottom plane and cause the capture of coded information (such as, but not limited to, bar code) upon the alignment of such information with the reader. The bottle label, inner bottom plane, and reader portion may all utilize the present invention alignment indicia or marks to further facilitate the efficiency of capturing the appropriate coded information.

The purpose for another present invention embodiment of a coded data reader as described herein is to account for a variety of users and for providing the best utility for such users.

The embodiments of the main device described herein may be comprised of, but not limited to being comprised of, the following: a double side circuit board; a 120V/6V power transformer; a 120V 1A fuse; a 5V 1A voltage regulator with shutdown capability; a 1A power bridge rectifier; a 3V lithium coin cell battery backup component; a microcontroller (high end is preferable to accommodate present invention and future invention robust functionality); a crystal oscillator; associated connectors and cabling as appropriate per configuration; a key sealed touchpad; associated communications interfaces, chip sets (as described throughout the narrative), transformers, other magnetics, antenna, High Frequency passive elements, and sockets, as appropriate for the respective communications means; resistors and capacitors for the preceding; and an IR transceiver for the applicable medical device and/or scanner adjunct.

Another invention embodiment is to provide the means for such system 120 in FIGS. 24, 25 and partially shown in FIG. 26, as well as its associated systems described and illustrated herein to account for user interaction and health care provider personnel record keeping. For example, a program associated with coded data reader 124, and other present invention coded data reader embodiments may request user or care provider practitioner confirmation that the medication or vitamin was taken. Such request may be initiated by an audio (such as, but not limited to a chirp) and/or visual (such as, but not limited to a text message) prompt. Such user or care provider practitioner confirmation may be registered by, as previously noted, having the user or practitioner press a button that may be located on a panel comprising one or more buttons that may reside above, below, and/or on the side of a display screen that may reside on or near the reader (which may be located on, but not limited to, a cabinet door mount). Such button may be highlighted by a field that may be seen on the display alongside such button. Such user input means may also be, but not limited to, speech recognition or voice command based input prompts.

The means for prompting user input also provides user and/or associated health care providers with greater utility in tracking practitioner and patient care. For example, at minimum, such practitioner may have a bar code or other coded data label on a badge or wallet card identifying the name of such practitioner as a means for registering such practitioner information with the drug administration program for a number of uses such as, but not limited to, record and quality control purposes. The user or patient may also have such form of identification. The purposes for such information may vary pending on the location, circumstances and application (for example, at one's residence versus an elder care or hospital facility versus a methodone clinic), and, thus may present other applicable present invention embodiments such as the means to provide a medicine lock box that may not be accessed by anyone other than an authorized card holder or a health provider from a remote facility via a server, communications and processor link to such lock box.

The uses and services associated with the present invention medical and health systems and components described herein may also be considered as invention embodiments where such information may be utilized or incorporated, in whole or in part, with existing or new services from a variety of health services, pharmaceutical, and information technology industry entities such as, but not limited to, a web site health and/or health care provider or institutional health and/or medical provider. Such services may be, but not limited to, alert, notification, medical home care administration, and/or monitoring services or in medication ordering services, programs or functions. In addition, such services, in whole or in part, may also be associated with environmental safety and/or security services system providers and systems such as the present invention environmental and security sensor and alert system(s) submitted in previous filings.

Most of the present invention embodiments may be manufactured of commonly available materials. The electrical, processor and communications device circuitry and electrical elements employed are commonly available and known to one skilled in the art, although not in the configuration and arrangement of the present invention.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

Server Component and Services:

As noted throughout this filing, and the paragraphs preceding this narrative heading, the present invention devices and systems described herein may deliver greater utility when their functionality accounts for operating, either directly or indirectly, with (a) present invention server component(s ).

Such server(s) and associated software, memory, hardware and peripheral(s) component may be adapted for one or more of the following:

information receipt, processing, inquiry, presentation and/or dissemination

alert, notification, and intervention

interactive functions and programs

uploadable and downloadable data, information, programs, and programming

scalable architecture and infrastructure and economy of network medium(s) and facilities

redundant and/or backup configuration

a variety of advertising, marketing-based and/or information/news-based services and mediums

networked and distributed architecture and deployment associated with the preceding.

This present invention server system, in whole or in part, may function for a variety of constituent communities as intra, inter, and/or extranet embodiments.

The constituents and entities may comprise, but are not limited to comprising, the following: health and medical communities—patients; middle aged through elderly individuals; families; parents; the sandwich generation; assisted living facilities; health services providers; insurance providers; third party administrators; out-patient facilities; hospitals; managed care providers; health, medical and psychiatric facilities and/or institutions; anyone with a disability, disease, chronic condition or injury requiring medication regimens or assistance; doctors; nurses; pharmaceutical industry; medical device industry; market research entities; and emergency response personnel—authorized EMTs, policemen, and firemen.

The information receipt, processing, inquiry, presentation, and/or dissemination capabilities of the present invention system medical and health server embodiment may comprise a variety of functions and information content, reporting, dissemination and templates based on the constituent group utilizing the server system.

For example, the information and report presentation for a doctor's inquiry may have more specific or solely scientific terms in comparison to a report generated from a family member user inquiry. In another example, a visiting nurse practitioner may access the web site with appropriate login permissions to confirm or close out a patient visit regimen. Such site page associated with this type of patient profile may be only accessible by authorized parties. Other profiles, such as a patient profile and vitals record, as described in a previous section, may only be accessed by authorized personnel under certain conditions such as an emergency with appropriate patient and/or family consent.

A present invention server program information profile (associated with the uploading of metrics from present invention devices to such server) may comprise various historical and trending functions. It may be presented on a server program site page with a search engine link associated with a patient's condition to facilitate, for example, user family member understanding of a user's health condition. For example, if a diabetic may have been incurring a consistent sugar level reading over a certain period, then he/she or his/her family member may want to utilize a search function to obtain more information about practices or products that support reducing such reading. In addition, such site page may also offer emailing capabilities associated with various types of diabetic information sources, from, but not limited to, treatment news to association news or meetings.

The dissemination of patient information, as well as alert, notification and intervention information and means may be best utilized through the present invention server system.

Though a number of present invention system devices described herein may communicate to other devices and/or serve as hub devices to support economy of resources, functionality and infrastructure and first level alert and intervention, the server component utilizes the best means for effective, comprehensive and economical communication. Such information dissemination, alert, notification and intervention may be delivered to portable devices such as, but not limited to, PDAs, cell phones, integrated cell phone/PDA devices, various portable PCs, watches, eyewear, and/or ear phones/headphones; and non-portable devices such as PCs, and/or receipt and dispatch stations or centers.

The present invention interactive functions and programs may range from, but is not limited to, accommodating visiting nurse practitioner patient visit/regimen confirmation, where such confirmation may generate a confirmation number to secure a compliance record of such confirmation, to drug trial user feedback sessions.

The uploadable functions associated with the present invention may range from, but is not limited to, reporting medication and/or physical therapy regimen compliance to insurance providers and/or third party administrators, to reordering prescriptions based on a main device 100 or 10 and/or various pill enclosures (such as, but not limited to, with weight scales) and/or dispensers and/or server prescription and dosage record program triggering such ordering activity. Another key present invention utility is the downloading of a prescription program to the main device upon the transmission of such program from the originating physician and/or pharmacist. Another helpful present invention downloadable function is changing device threshold/exception parameters, which is especially helpful for users who are not accustomed to administering any type of device or who may have an aversion or uneasiness to performing such function. In this example, an authorized family member, who may live remotely, may access the present invention web site profile (with appropriate login permissions) and change a medical device parameter. It is important to note that certain device administration functions may only be permissible by authorized medical professionals, such as changing a drug regimen. The ability to perform such administration remotely greatly supports efficient resource time.

The server component of the present invention system also supports economy of scale for supporting widespread acceptance. Such component is accounted for under a scalable architecture that may utilize a bundling of network mediums from high portal throughput to volume pricing calling/messaging plans over various mediums such as, but not limited to, a variety of cellular and/or IP and/or other communications networks (LAN, WLAN, WAN, digital, UWB, Wi Max, basic dialed, etc.).

The system may comprise redundant and/or backup configuration deployments to support uptime for critical retrieval and functions such as emergency receipt, alert, notification and intervention.

The server site and associated information may be accessed by a variety of devices with various access means such as, but not limited to, browser-based and/or thin client portable and non-portable devices.

The access and operations efficiency of the server system may be supported by a distributed architecture.

The sensors, processors, memory, circuitry, electrical components, housings, fittings and bonding and securing means for the components described herein are comprised of conventional materials, designs and configurations, except for the designs associated with the present invention embodiments described herein.

It is also understood that the network protocols and means described herein may evolve or be modified where such modification may support other like protocol standards that may also be adapted with the present invention system and be construed as present invention embodiments when utilized, integrated or comprised with or in such present invention apparatuses, devices and/or systems. Protocols such as, but not limited to, ZigBee, Wi Fi, Bluetooth, UWB, HomePlug™ and Ethernet compatible network protocols, and respective offshoots of such protocols apply to the preceding statement related to such present invention embodiments. In addition, the Wi Fi standards associated with or supporting at least one or more of the present invention embodiments described herein are, but not limited to, the following: 802.11g; 802.11b; 802.11a; or 802.11n. Portions of the present invention system, such as, for example a main device 100, 110, system 120 or timer or controller embodiment may comprise Wide Area Network communications interfaces to interact with Wi Max, broadband, DSL, high-speed cable, (and)/or dial-up networks.

Obviously, numerous modifications and variations of the present invention are possible in light of the above teachings. It is therefore understood that within the scope of the appended claims, the invention may be practiced otherwise than as specifically described herein.

1. A multifunction-capable air purifier device, which comprises:
a) a main housing having at least one air purifying mechanism contained therein, said main housing including air ingress and egress ports;
b) a multifunction-capable enclosure adapted to encompass at least a portion of said main housing;
c) at least one processor module connected to said enclosure, said module containing at least one processor adapted to operate at least one power consuming component selected from the group consisting of entertainment components, local area networked components, wide area networked components, communications components and electronic components;
d) power sourcing means connected to said at least one air purifying mechanism and to said at least one processor.

2. The multifunction-capable air purifier device of claim 1 wherein said air purifying mechanism is selected from the group consisting of an air filter mechanism, an air ionizer mechanism, an electrostatic precipitator mechanism, an air deodorizer mechanism and combinations thereof.

3. The multifunction-capable air purifier device of claim 1 wherein said power sourcing means is selected from the group consisting of wiring and an AC plug, wiring and a DC plug, a battery powering means, a solar powering means and combinations thereof.

4. The multifunction-capable air purifier device of claim 1 which further includes a collar adapted to be removably attached to said enclosure.

5. The multifunction-capable air purifier device of claim 4 wherein said collar includes at least one electrically driven component that is functionally connected to at least one processor module of said enclosure.

6. The multifunction-capable air purifier device of claim 5 wherein said at least one electrically driven component is selected from the group consisting of a receiver, a transmitter, a motion sensor, a device controller chip and at least a second multi-function capable air purifier device.

7. The multifunction-capable air purifier device of claim 6 wherein said device controller chip includes control capability for said at least one air purifying mechanism.

8. The multifunction-capable air purifier device of claim 4 which further includes a top component adapted to be removably connected to said collar.

9. The multifunction-capable air purifier device of claim 8 wherein said top component includes a power driven device selected from the group consisting of an antenna, a receiver, a transmitter, an environmental element detector and a motion detector.

10. The multifunction-capable air purifier device of claim 1 which further includes connection to at least a second multifunction-capable air purifier device, wherein said second multifunction-capable air purifier device is connected to said multifunction-capable air purifier via connection means selected from the group consisting of wire connection, wireless connection and combinations thereof.

11. The multifunction-capable air purifier device of claim 10 wherein said second multifunction-capable air purifier device further includes a collar adapted to be removably attached to said enclosure.

12. The multifunction-capable air purifier device of claim 11 wherein said second multifunction-capable air purifier device further includes at least one electrically driven component that is functionally connected to at least one processor module of said enclosure.

13. The multifunction-capable air purifier device of claim 12 wherein said second multifunction-capable air purifier device further includes at least one electrically driven component selected from the group consisting of a receiver, a transmitter, a motion sensor, a device controller chip and at least an additional multifunction-capable air purifier device.

14. The multifunction-capable air purifier device of claim 13 wherein said device controller chip includes control capability for said at least one air purifying mechanism.

15. The multifunction-capable air purifier device of claim 11 wherein said second multifunction-capable air purifier further includes a top component adapted to be removably connected to said collar.

16. The multifunction-capable air purifier device of claim 15 wherein said second multifunction-capable air purifier further includes a power driven device selected from the group consisting of an antenna, a receiver, a transmitter, an environmental element detector and a motion detector.

17. A multifunction-capable material dispensing and tracking system, which comprises:
a) a container for containing a plurality of material items;
b) a cover removably attachable to said container;
c) a plurality of material items having at least one of a bar code, a radio frequency identification component, a printed data encoded component, an encoded DNA-mark and readable optical characters, containing material item information, said plurality of material items adapted to be placed in or removed from said container;
d) an information perceiving and receiving device having at least one information recognition mean selected from the group consisting of a bar code scanner, a radio frequency identification component reader, a coded data reader, a hologram reader and an optical character recognition reader, said information perceiving and receiving device being connected to one of said container and said cover;
e) at least one processor having data input, data processing, data storage and data output means, and having sufficient hardware and software to receive, store, organize and present dispensing and tracking device cover and material item usage at least by date, time, and material item identification;
wherein a user removes a material module from said container, register information therefrom by passing in the vicinity of said information perceiving and receiving device and then using at least some material therefrom, or a user may use at least some material from a material item, register information therefrom by passing in the vicinity of said information perceiving and receiving device and then placing said material item in said container, and whereby the information so registered is organized, stored and retrievable.

18. The multifunction-capable material dispensing and tracking system of claim 17 wherein said at least one processor includes a clock and calendar feature and has software that stores required times for material consumption by a user, compares required times to actual registered times, and matches required and registered times, and when required and registered times deviate by more than a present tolerance, sends a communication to warn a user of non-compliance.

19. The multifunction-capable material dispensing and tracking system of claim 18 wherein said communication is selected from the group consisting of at least one of an audible alarm, a visual alarm, a vibratory alarm, a wired transmitted message, and a wireless transmitted message.

20. The multifunction-capable material dispensing and tracking system of claim 17 wherein said at least one processor includes a clock and calendar feature and has software that stores required times for material consumption by a user, compares required times to actual registered times, and matches required and registered times, and when required and registered times deviate by more than a present tolerance, sends a communication to warn a third party of non-compliance wherein said communication is selected from the group consisting of at least one of an audible alarm, a visual alarm, a vibratory alarm, a wired transmitted message, and a wireless transmitted message.

21. The multifunction-capable material dispensing and tracking system of claim 17 wherein said processor includes communication means for communicating stored information to a remote device selected from the group consisting of a local area networked device, a wide area networked device, a local server, a remote server and combinations thereof.

22. The multifunction-capable material dispensing and tracking system of claim 21 wherein said communication means is selected from one or more of the group consisting of a local area network system, a wide area network system, a display system, a wired system, and a wireless system.

23. The multifunction-capable material dispensing and tracking system of claim 17 wherein said device further includes locking means to lock and unlock said cover relative to said container in response to prescribed input.

24. The multifunction-capable material dispensing and tracking system of claim 23 wherein said locking means includes processing means to respond to an input selected from the group consisting of an electronic input, a manual input, a perceived and recognized input with a comparative analysis, and combinations thereof.

25. The multifunction-capable material dispensing and tracking system of claim 17 wherein said plurality of material items are selected from the group consisting of prescription medicine containers, non-prescription medicine containers, syringes, medicine dispensers and medicine blister packs.

26. The multifunction-capable material dispensing and tracking system of claim 17 wherein said container is a storage container for material items wherein said material items are selected from the group consisting of health items, toxic items, radioactive items, sharps, and documents.

27. The multifunction-capable material dispensing and tracking system of claim 17 wherein said container is a spent material waste disposal container wherein said material is selected from the group consisting of health material, toxic material, radioactive material, sharps material, and shredded material.

28. An electronic information recognition system having an information perceiving and receiving device having at least one information recognition means selected from the group consisting of a bar code scanner, a radio frequency identification component reader, a data encoded component reader, a hologram reader and an optical character recognition reader and combinations thereof, and having a plurality of readable material items having at least one coded information packet corresponding to said device and selected from one or more of the group consisting of a bar code, a radio frequency identification component code, a printed data encoded packet, a DNA-mark packet and readable optical characters, the improvement which comprises:
providing an information recognition enhancing alignment indicia on said plurality of readable material itmes, said information recognition enhancing alignment indicia being different and separate from said coded information packets.

29. The electronic information recognition system of claim 28 wherein said information recognition enhancing alignment indicia are located in a different area on said plurality of readable material items from said coded information.

30. The electronic information recognition system of claim 28 wherein said information recognition enhancing alignment indicia are located in a same area on said plurality of readable material items as said coded information.

31. The electronic information recognition system of claim 28 wherein each said information recognition enhancing alignment indicia has at least two components, at least one being located in a different area on said plurality of readable material items from said coded information, and at least one being located in a same area on said plurality of readable material items as said coded information.

32. The electronic information recognition system of claim 28 wherein said readable material items have a front and a back and said coded information is located on one of said front and said back, and said indicia is located on the other of said front and said back.

33. The electronic information recognition system of claim 28 wherein said indicia is an alignment mark selected from the group consisting of a line, at least two aligned shapes, at least two aligned dots, at least two aligned symbols and combinations thereof.

34. The electronic information recognition system of claim 33 wherein said alignment mark is selected from the group consisting of a vertical alignment bar, a horizontal alignment bar and a diagonal alignment bar.

35. The electronic information recognition system of claim 28 wherein said indicia is a sign in any language giving instruction to a user.

36. The electronic information recognition system of claim 35 wherein said indicia is a sign that contains a term selected from the group consisting of ALIGN, PLACE, SCAN, HERE and PLACE HERE.

37. The electronic information recognition system of claim 28 wherein said indicia is at least partially located within said coded information packet.

38. The electronic information recognition system of claim 28 wherein said indicia is color coded.

39. The electronic information recognition system of claim 28 wherein indicia is a symbol.

40. The electronic information recognition system of claim 28 wherein said indicia is a shape.

41. The electronic information recognition system of claim 28 wherein said indicia is a topographical feature selected from the group consisting of indentation, detent, combinations of indentation and detent, Braille and combinations thereof.

42. The electronic information recognition system of claim 28 wherein said indicia is a combination of at least two features selected from the group consisting of color, shape, symbol, chemical and topographical feature.

43. The electronic information recognition system of claim 28 which improvement further includes at least one information recognition enhancing alignment indicia on said information perceiving and receiving device.

44. The electronic information recognition system of claim 28 wherein said system is part of a group consisting of an integrated health care system, an integrated security system, an integrated identification system, an industrial process system, and a commercial process system.

45. The electronic information recognition system of claim 44 wherein said system is an integrated health care system.

46. The electronic information recognition system of claim 45 wherein said integrated health care system includes a medicine compliance and intervention system.

47. The electronic information recognition system of claim 46 wherein said medicine compliance and intervention system includes at least one component selected from the group consisting of prescription medicine containers, non-prescription medicine containers, syringes, medicine dispensers and medicine blister packs.

48. The electronic information recognition system of claim 46 wherein said medicine compliance and intervention system includes a data base with match and communicate capabilities using at least one non-compliance parameter selected from the group consisting of correct versus incorrect medication, correct versus incorrect dosage, correct versus incorrect time, correct versus incorrect user, and failure to read.

49. The electronic information recognition system of claim 46 wherein said medicine compliance and intervention system includes a multifunction-capable material dispensing and tracking system, which comprises:
a) a container for containing a plurality of material items;
b) a cover removably attachable to said container;
c) a plurality of material items having at least one of a bar code, a radio frequency identification component, a data encoded component, a hologram, and readable optical characters, containing material item information, said plurality of material items adapted to be placed in and removed from said container;
d) an information perceiving and receiving device having at least one information recognition mean selected from the group consisting of a bar code scanner, a radio frequency identification component reader, a coded data reader, a hologram reader and optical character recognition reader and combinations thereof, said information perceiving and receiving device being connected to one of said container and said cover;
e) at least one processor having data input, data processing, data storage and data output means, and having sufficient hardware and software to receive, store, organize and present dispensing and tracking device cover and material item usage at least by date, time, and material item identification;
wherein a user removes a material module from said container, register information therefrom by passing in the vicinity of said information perceiving and receiving device and then using at least some material therefrom, or a user may use at least some material from a material item, register information therefrom by passing in the vicinity of said information perceiving and receiving device and then placing said material item in said container, and whereby the information so registered is organized, stored and retrievable.

50. An electronic prescription filling and tracking system using an information perceiving and receiving device having at least one information recognition means selected from the group consisting of at least one of a bar code scanner, a radio frequency identification component reader, a coded data reader, a hologram reader and an optical character recognition reader, and using a plurality of readable material items having at least one coded information packet corresponding to said device and selected from at least one or more components from the group consisting of a bar code, a radio frequency identification component, a data encoded component, a hologram and readable optical characters and combinations thereof, the improvement which comprises:
providing an information recognition enhancing alignment indicia on said plurality of readable material items, said information recognition enhancing alignment indicia being different and separate from said coded information packet.

51. The electronic prescription filling and tracking methodology of claim 50 which improvement further includes providing at least one information recognition enhancing alignment indicia on said information perceiving and receiving device.

52. The prescription filling and tracking system of claim 50 which improvement further includes operating a medicine compliance and intervention system includes a data base with match and communicate capabilities using at least one non-compliance parameter selected from the group consisting of correct versus incorrect medication, correct versus incorrect dosage, correct versus incorrect time, correct versus incorrect user and failure to read.

53. The prescription filling and tracking system of claim 50 which improvement further includes operating an electronic prescription originating system.

54. The prescription filling and tracking system of claim 50 which improvement further includes operating an electronic prescription ordering system.
